(19) United States
(12) Patent Application Publication
(10) Pub. No.: US 2002/0092485 A1
(43) Pub. Date: Jul. 18, 2002

(54) FREE PISTON ENGINE AND SELF-ACTUATED FUEL INJECTOR THEREFOR

(76) Inventors: Richard C. Alexius, (US); Karl R. Alexius, Orlando, FL (US); Renee S. Alexius, Orlando, FL (US)

Correspondence Address: BIRCH STEWART KOLASCH & BIRCH, PO BOX 747, FALLS CHURCH, VA, 22040-0747, US

(21) Appl. No.: 09/984,415

(22) Filed: Oct. 30, 2001

Related U.S. Application Data
(62) Division of application No. 09/500,468, filed on Feb. 9, 2000, now Pat. No. 6,349,682.

(51) Int. Cl. F02B 71/00; F02M 47/02

(52) U.S. Cl. 123/46 R; 239/88

(57) ABSTRACT

A simple propulsion engine utilizing unheated atmospheric air as the propellant, and driven by a single cycle (unicycle) engine with internal combustion cylinder and free piston is disclosed. A free piston with an annularly arranged thrust piston to divide a dual-diameter cylinder into two combustion chambers and two thrust chambers is provided. Scavenge feeder lines connected the thrust chambers to the combustion chambers via check valves provide exhaust scavenging, additional thrust output through exhaust nozzles, and feeding of fresh air into the combustion chambers. Also, pressure-actuated fuel injectors utilize pressure changes in respective combustion chambers to inject fuel at the appropriate time. The fuel injector includes an intensifier piston and pintle to raise the fuel pressure.

This Application is a divisional of co-pending Application No. 09/500,468, filed on Feb. 9, 2000, the entire contents of which are hereby incorporated by reference.

### BACKGROUND OF THE INVENTION

1. Field of the Invention

This invention is in the field of propulsive machines cooperating with internal combustion, free piston engines and compressors to produce motive power, lifting, or other uses. This invention also relates to a self-actuated fuel injector that may be utilized in such an engine.

2. Background of the Invention

Numerous inventions known in the prior art have been developed, and many proposed which are based on the Newtonian principle of reactive propulsion. Propellers and helicopter rotors, jet engines, and rockets are the principal examples of that genre.

Propellers and rotors, however, require complex internal combustion or gas turbine engines to supply rotating torque to airfoil shaped blades. Large amounts of unconstrained, low pressure air is propelled aftward of the propeller/rotor due to the lift and screw action of the airfoil shaped blades, creating thrust and invoking the concomitant slip, drag, and kinetic energy air stream losses. The total fuel efficiency of these systems is determined primarily by the engine and propeller inefficiencies. In the present invention, there are no propeller losses, and engine losses and engine weight are minimized by the elimination of piston rods, crankshafts, flywheels, transmissions, and, in the case of turbines, high soak temperature turbine blading, adjunct compressors, and internal flow losses.

Chemical thermal-jet engines utilize ram air and axial flow or centrifugal compressors to force air into an engine inlet and raise its pressure in a combustion chamber. In the combustion chamber, fuel is injected and burned creating high temperature, high velocity gases. Part of the gas velocity energy is used up driving turbine blades for the compressor, and the gas then exits a nozzle to produce thrust. Large thermal losses are incurred due to the extreme temperatures at which the jet engine must operate. Rocket engines carry fuel and oxidizer internally and generate their propulsive gasses from within.

Free piston internal combustion engine and compressor combinations are well known, and the prior art contains many examples of various concepts and configurations. None were found which incorporates a power stroke at each end of a single cylinder and uses an unadorned, simple piston whose only functions are to separate the combustion and compression chambers and provide inertial energy storage. Free piston engines and compressors disclosed in the literature are complex and heavy devices which go to great lengths to counteract cylinder reaction to the acceleration of the piston(s) by the use of elaborate spring-counterweight mechanisms or tandem pistons synchronized by rack and pinions, linkages, gears, or other mechanical means.

However, there are no feasible, chambered high pressure propulsion systems that utilize unheated atmospheric air, on a continuous basis, as the main propellant medium. The reason for this is undoubtedly the difficulty of conceiving an engine and compressor combination that is simple and lightweight enough to make it practical.

### SUMMARY OF THE INVENTION

The present invention involves a major change in the concept of vertical lifting and locomotion in each of the primary modes of land, air, and marine propulsion. As a necessary prerequisite to invention of the atmospheric propulsion engine, the unicycle free piston engine was invented as described herein. The combination of atmospheric air propellant and unicycle free piston engine are part of the unique and defining elements of the present invention.

The single cycle free piston engine disclosed herein uses a simple lightweight piston which minimizes the reactive movement of the cylinder assembly (this movement being a function of the ratio of piston mass-to-cylinder assembly mass).

This present invention is an atmospheric propulsion engine, firing its free piston at each end of the cylinder, scavenging of exhaust products, and natural self cooling due to the large internal ingestion of atmospheric air.

As an indication of the efficacy of the atmospheric propulsion engine, a simple calculation is presented. A cylinder 1.5 inches in diameter, and 18 inches long contains a volume of 31.8 in² and has a weight of air equal to 0.0014 lbs. at standard atmospheric conditions. When this mass of air is expelled at 70° F. (520° R), at sonic velocity, in 0.010 seconds through a thrust-producing nozzle, a force of 4.83 lbs. is generated. If this same mass of air is expelled at the temperature and pressure corresponding to a 10 to 1 compression ratio (1300° R and 370 psi), the force generated would be 7.71 lbs.

The atmospheric propulsion engine will produce a thrust (force) somewhere between the above numbers, and a computer simulation of the above configuration indicates that an average thrust of 6.4 lbs. can be achieved. Using aircraft type construction, it is estimated that such a device would weigh about 2.1 lbs., yielding an engine thrust-to-weight ratio of 3-to-1. Based on this evaluation, the atmospheric propulsion engine would be suitable for flying and hovering applications, as well as numerous other uses discussed in the following descriptions.

Note: The above performance calculations are based on the following formulas:

Thrust=Mass of air×Sonic velocity/time

Sonic velocity=\sqrt{k×g×R×T}

Where:

k=Ratio of specific heat for air=1.4

g=Gravity constant=386.4 in./sec²

R=Gas Constant=640 in-lb/lb-°F.

T=Temperature °R

The specific impulse of the above configuration is calculated to be in the 2000 to 4000 lb-sec/lb range using standard automotive gasoline or diesel fuel.

A comparison of existing art with the present invention of the atmospheric propulsion engine reveals the superior characteristics of the concept and method.

This invention directly converts the fuel's thermal energy primarily into mechanical Pressure/Volume (PV) forces, compressing atmospheric air and expelling it at sonic velocity to efficiently generate thrust. The only major moving part in the atmospheric propulsion engine system is the internally shared engine/compressor piston which presents another major advantage of this invention, especially in the case of helicopters, by the elimination of noisy and dangerous external rotating propellers and rotor blades.

In the present invention, most of the fuel's thermal energy is used up in the PV expansion process of the working fluid to drive the piston, thus, after the compressed air propellant is expanded in the thrust nozzles, a relatively cool, benign gas is expelled. No compressor is required as atmospheric pressure is adequate to refill the expulsion gas chamber. However, superchargers, or in applications involving moving vehicles, ram air, can be utilized to raise the compressor inlet pressure, thus enhancing compressor volumetric efficiency and increasing the engine's thrust-to-weight ratio.

Applications for an independent, free standing thrust engine are manifest.

Given a nominal engine thrust to weight ratio of 3 to 1, coupled with the benignity of the exhaust products, it becomes feasible to design and market a personal passenger vehicle which can fly to its destination without having to concern itself with roads, bridges, or other ground based obstacles. This thrust to weight ratio also may make the engine applicable to “backpack” individual flying machines. Steering, stability and control of such flying machines can be accomplished through thrust vector control mechanisms such as movable nozzles or jet vanes as shown in FIGS. 10 and 11, or may be implemented by other well known aerodynamic means available in the existing art.

Much effort has been expended in the quest for reducing weight and increasing the efficiency of automobiles to combat air pollution. An automobile designed using the lightweight atmospheric propulsion engine disclosed herein would preclude the necessity for flywheels, crankshafts, piston rods, cooling systems, transmissions, driveshafts, differentials, and drive axles. This would eliminate the weight, power losses, and thermal inefficiencies due to these components. Probably, 50% or more of an automobile's weight could be eliminated and fuel requirements reduced considerably. In addition, the propulsion drive would make vehicle acceleration independent of tire traction. A passenger car could be designed with forward and rearward facing thruster nozzles to control acceleration and braking (thrust reversal, as shown in FIG. 6), and vectored nozzles could control steering to effect a vehicle which is independent of road and tire friction. Or, a hybrid of conventional braking and steering with propulsive drive could be contrived. These same characteristics apply to travel over water, snow, and ice.

Present ground effect machines (GEM) require substantial amounts of air to create sufficient pressure in the vehicle-to-surface interface plenum with which to support the gravity load and provide sufficient surface clearance. This is normally accomplished by the use of large, noisy, inefficient fans. The present invention could be used to provide partial lift from its propulsion engine(s), while using the nozzle exhaust to pressurize the, GEM interface plenum. The small plenum back pressure would have little effect on the nozzle's thrust efficiency.

Aircraft propulsion would benefit from this invention's enhanced engine specific impulse and from the availability of high speed ram air to increase the propulsion chamber's volumetric efficiency, thus minimizing the size and weight of the overall propulsion system. The availability of simple, full engine thrust reversal would greatly increase aircraft braking capabilities and reduce runway rollout.

The atmospheric propulsion engine can be slidably mounted to its structure with a simple centering spring mechanism and allowed to traverse a small distance back and forth as shown in FIG. 8. This engine can also be configured in tandem opposed end-to-end combinations to eliminate reactive engine movement, with synchronization being accomplished by a correct starting procedure, metering of fuel, and timing of the ignition process. FIG. 7 shows schematically how two tandem engines could be configured.

In addition to its use in the atmospheric propulsion engine, the simplicity and lightweight of the single cycle free piston engine disclosed herein is desirable for other engine applications such as air compressors and power tools.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF DRAWINGS

The present invention will become more fully understood from the detailed description given hereinbelow and the accompanying drawings which are given by way of illustration only, and thus are not limitative of the present invention, and wherein:

FIG. 1 is a schematic cross section of the atmospheric propulsion engine of a first embodiment made up of the unicycle free piston engine and propulsion components;

FIG. 2 is the schematic of FIG. 1 with the piston in firing position at the left end of the cylinder;

FIG. 3 is the schematic of FIG. 1 with the piston crossing the inlet/exhaust ports at the left-of-center cylinder region;

FIG. 4 is the schematic of FIG. 1 with the piston crossing the nozzle port on the right end of the cylinder;

FIG. 5 is the schematic of FIG. 1 with the piston in firing position at the right end of the cylinder;

FIG. 6 is the schematic of FIG. 1 showing an engine configuration with discrete thrust reversal nozzles and valving;

FIG. 7 is a configuration of engines in tandem to eliminate reactive cylinder movements;

FIG. 8 shows a spring centered, slidably mounted engine to allow reactive movements;

FIG. 9 is a schematic of an integrated atmospheric propulsion system with fuel, compressed air, and electrical components;

FIG. 10 shows a conventional swivel nozzle concept that may be utilized in conjunction with the inventive engine;

FIG. 11 shows a conventional jet vane concept that may be utilized in conjunction with the inventive engine;

FIG. 12 is a schematic cross section of a second embodiment of the inventive engine;

FIG. 13 is the schematic of FIG. 12, with the piston in firing position at the left end of the cylinder;

FIG. 14 is the schematic of FIG. 12 with the combustion in the left combustion cylinder in progress;

FIG. 15 is the schematic of FIG. 12 with the piston at the midpoint of its stroke and at maximum velocity;

FIG. 16 is the schematic of FIG. 12 compressing the right combustion chamber;

FIG. 17 is the schematic of FIG. 12 in firing position at the right end of the cylinder;

FIG. 18 is a schematic of an inventive self-actuated fuel injector that may be utilized with the second embodiment of the inventive engine;

FIG. 19 is a schematic of the inventive self-actuated fuel injector of FIG. 18 during an injection phase of operation; and

FIG. 20 is a schematic of the inventive self-actuated fuel injector of FIG. 18 during a reset phase of operation.

### DETAILED DESCRIPTION OF PREFERRED EMBODIMENTS

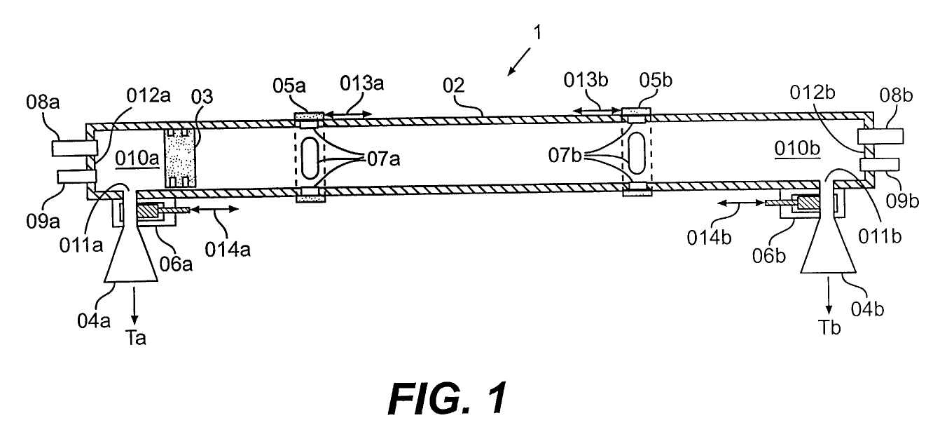

The first embodiment of the atmospheric propulsion engine is illustrated schematically in FIG. 1, and generally by reference numeral 1. It is a single-cycle (unicycle), spark ignition engine and compressor having a cylinder 02 with cylinder heads 012a and 012b on each end and having a piston 03 slidably interposed therebetween, forming alternate combustion and compression chambers 010a and 010b. Cylinder heads 012a,012b contain fuel injectors 08a,08b and igniters 09a,09b. The engine has thrust nozzles 04a,04b with associated valves 06a, 06b and actuators 014a,014b which sense piston 03 obturation of nozzle ports 011a,011b to effect appropriate valve, fuel injection, and ignition timing for sustained operation as further explained below.

The engine also has common exhaust/inlet ports 07a,07b which perform the dual functions of exhausting combustion gasses and admitting atmospheric air for propulsion, scavenging, and cooling. Exhaust/inlet ports 07a,07b are opened and closed by valves 05a,05b and associated actuators 013a,013b which sense obturation of exhaust/inlet ports 07a and 07b and enforce the appropriate valve action of valves 05a, 05b, 014a, and 014b.

The valves, actuators, fuel injectors, and igniters for the first embodiment are conventional elements whose description will be omitted here for the sake of brevity.

The operational cycle is defined as follows:

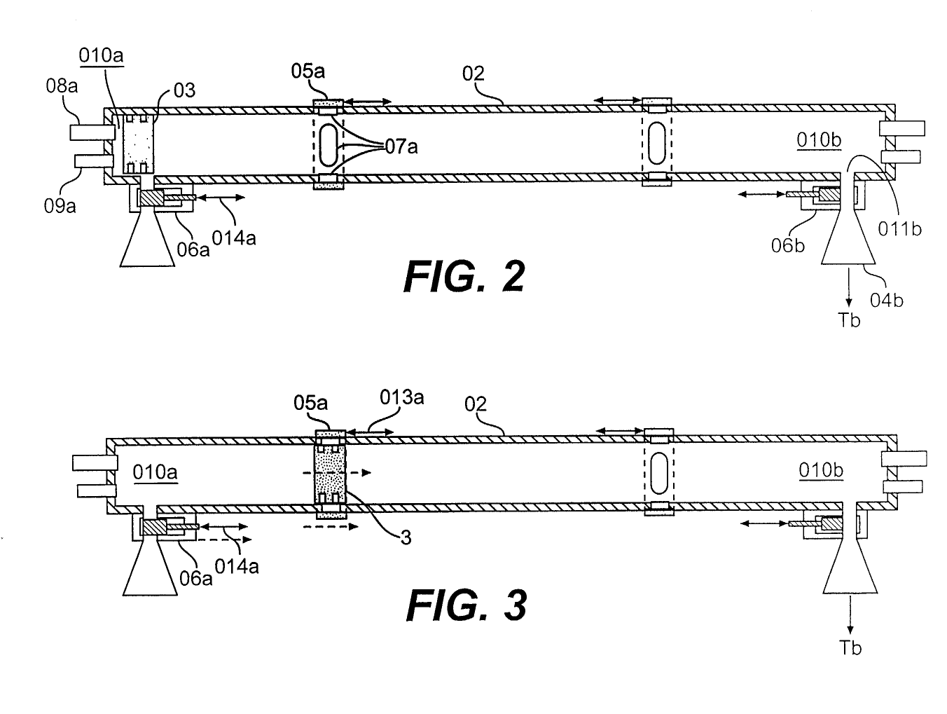

Referring to FIG. 2, piston 03 is positioned in cylinder 02 such that the air charge and fuel mixture in chamber 010a is at the required combustion pressure. With piston 03 in this position, igniter 09a is energized to initiate combustion in chamber 010a and begin the cycle. As further shown in FIG. 2, nozzle valve 6b is open, nozzle valve 06a is closed, and valves 05a,05b are closed at this part of the cycle and piston 03 begins accelerating to the right due to the combustion pressure in chamber 010a (dashed line arrows indicate movement).

As piston 03 moves to the right under the impetus of the combustion pressure in chamber 010a, the air/exhaust mixture in 010b is compressed and expelled through nozzle port 011b, open nozzle valve 06b and thrust nozzle 04b, thus generating the thrust Tb.

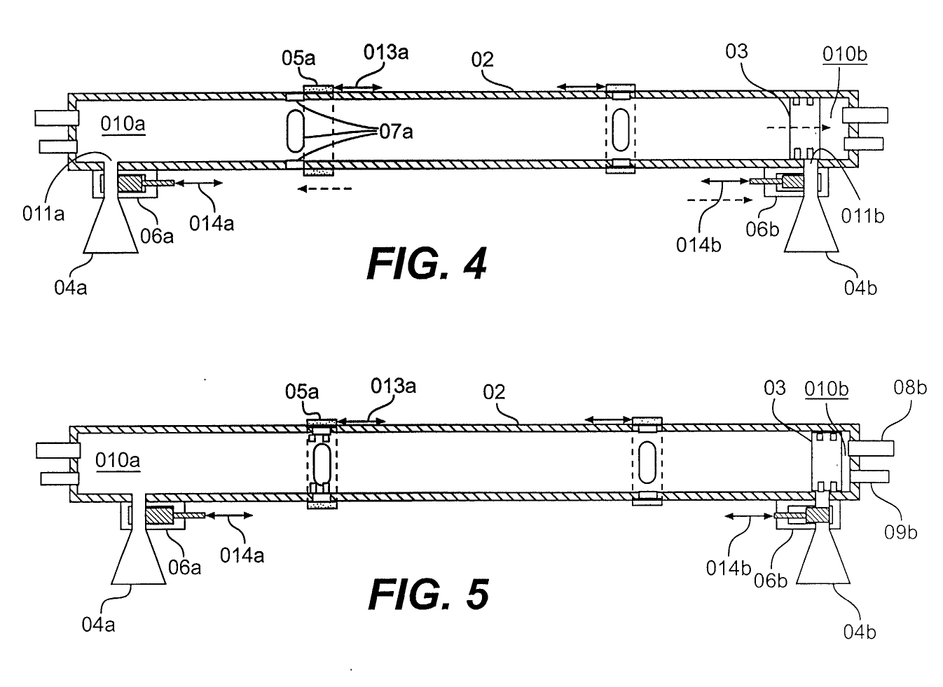

As shown in FIG. 3, when piston 03 crosses exhaust/inlet ports 07a, actuator 013a senses port 07a closure and opens nozzle valve 06a and causes actuator 13a to open exhaust/inlet port 07a via the valve 05a. FIG. 4, shows the opened state of nozzle valve 06a and exhaust/inlet port 07a. At this point, piston 03 reaches its maximum velocity.

The remaining unexpanded low-pressure combustion gasses are then exhausted through exhaust/inlet port 07a and nozzle port 011a, nozzle valve 06a, and thrust nozzle 04a. Meanwhile, piston 03 continues to travel to the right in cylinder 02 due to its inertial energy. The continuing rightward movement of piston 03, draws atmospheric air into chamber 010a through exhaust/inlet port 07a and nozzle 04a. Nozzle 04a is open at this event time to provide scavenging and dilution of the exhaust products.

The distance between nozzle port 011b and cylinder wall 012b is prefixed such that the mass of air charge required for subsequent combustion in chamber 010b is attained as piston 03 crosses and obturates nozzle port 011b as shown in FIG. 4.

At this point, the loss of high pressure in port 011b sensed by actuator 014b initiates five actions, shown in FIG. 4: the actuator 013a for slide valve 05a closes off exhaust/inlet ports 07a; the actuator 014b closes nozzle port 011b; the injector 08b injects a metered amount of fuel into chamber 010b; actuator 014a for nozzle valve 06a opens nozzle port 011a to nozzle 04a; and a delayed signal is sent to fire the igniter 09b when piston 03 achieves maximum compression in chamber 010b as shown in FIG. 5. The remaining inertial energy of piston 03 is dissipated in achieving the required combustion pressure in chamber 010b.

The atmospheric propulsion engine has completed one cycle and is in position to repeat the next cycle in the opposite direction. The sequence of this next cycle can be followed by substituting the a and b components for one another and reversing the piston's direction.

FIG. 6 illustrates how the inventive engine can be utilized to generate reverse thrust. Essentially, the thrust assembly including nozzle port, valve, actuator and thrust nozzle is duplicated. Specifically, nozzle port 011c is disposed opposite to nozzle port 011a and has attached thereto a valve 06c, actuator 014c and reverse thrust nozzle 04c. A corresponding nozzle port 011d is disposed opposite to nozzle port 011b and has attached thereto a valve 06d, actuator 014d and reverse thrust nozzle 04d. To generate reverse thrust, valves 06c and 06d would be activated instead of valves 06a and 06b, but with the same timing relationship as for valves 06a and 06b described above. The result is the generation of reverse thrust Tc and Td.

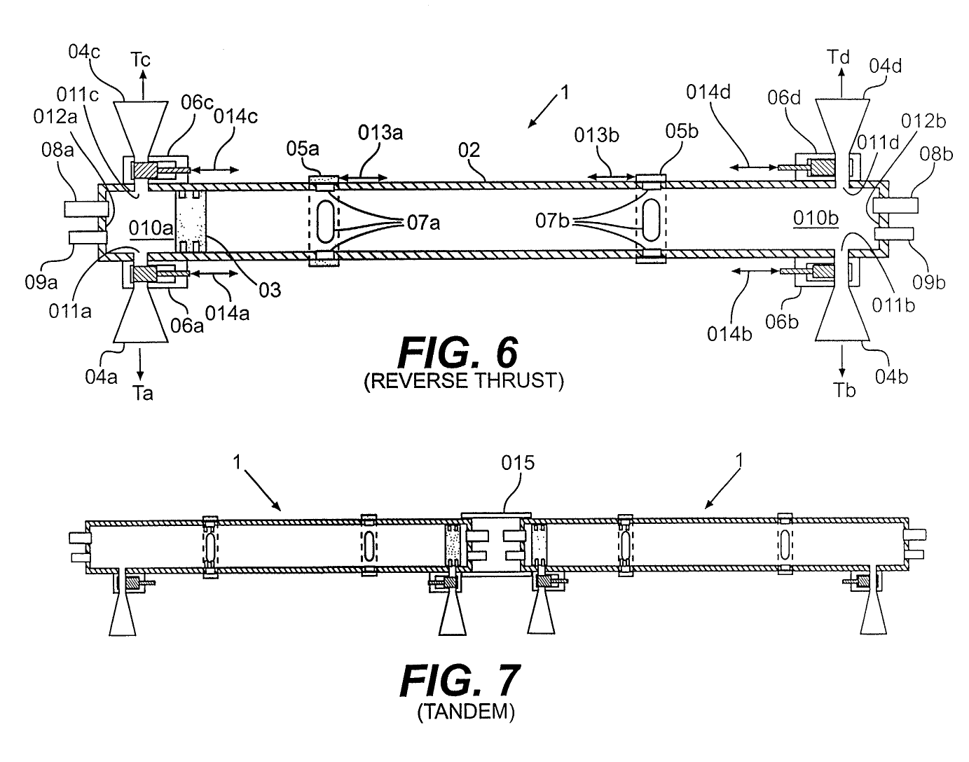

FIG. 7 illustrates a tandem engine design in which two engines 1 are mounted back to back as shown. A tandem configuration joining structure 015 is utilized to affix the two engines 1 to each other in the tandem configuration. In the tandem configuration fuel injection and ignition are synchronized to eliminate reactive engine movements. This synchronization may be accomplished via conventional rack and pinions, linkages, gears, or other mechanical means. Of course, the tandem design may also include a reverse thrust arrangement like the one shown in FIG. 6.

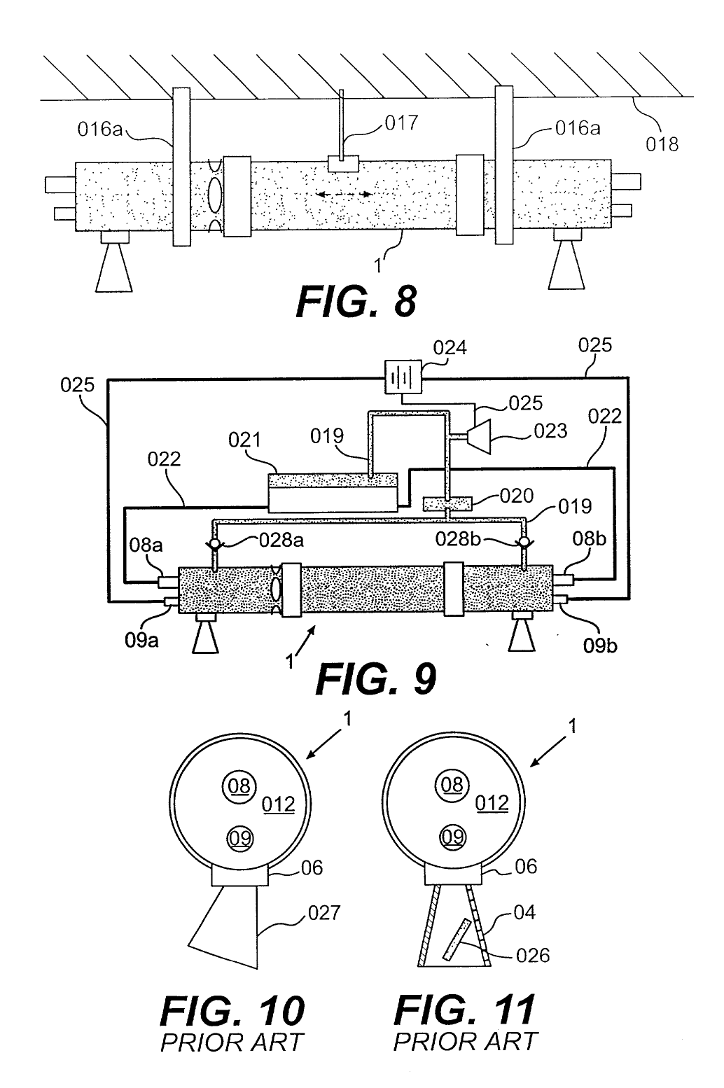

FIG. 8 shows a spring centered, slidably mounted engine to allow reactive movements. In other words, the atmospheric propulsion engine can be slidably mounted to a vehicle structure 018 via slidable engine mounts 016a and 016b and a centering spring mechanism 017 as shown in FIG. 8. In this way, the engine 1 can traverse a small distance back and forth with slidable engine mounts 016a,016b and centering spring mechanism 017 compensating for reactive forces generated by the engine 1.

FIG. 9 is a schematic showing how the unicycle engine indicated by reference 1 can be integrated into an operating system containing adjunct fuel and electrical systems. Gas lines 019 with check valves 028a and 028b are picked off of cylinder 02 to pressurize high pressure gas reservoir 020 and feed the pressurized fuel tank 021 and turbine generator 023. The fuel lines 022 feed fuel to fuel injectors 08a and 08b. Turbine generator 023 charges battery and electronics package 024 which transmits a timed firing signal to igniters 09a and 09b at the predetermined event time through electrical lines 025. Appropriate sensors may be utilized to sense the position of the piston via obturation of ports 07a,07b,011a, and 011b so that the actuators 013a,013b,014a,014b as well as the fuel injectors 08a,08b and igniters 09a,09b can be activated at the correct timing relationship that is described above. These sensors and activators may be, for example, electrical or pneumatic.

### Description of Second Embodiment

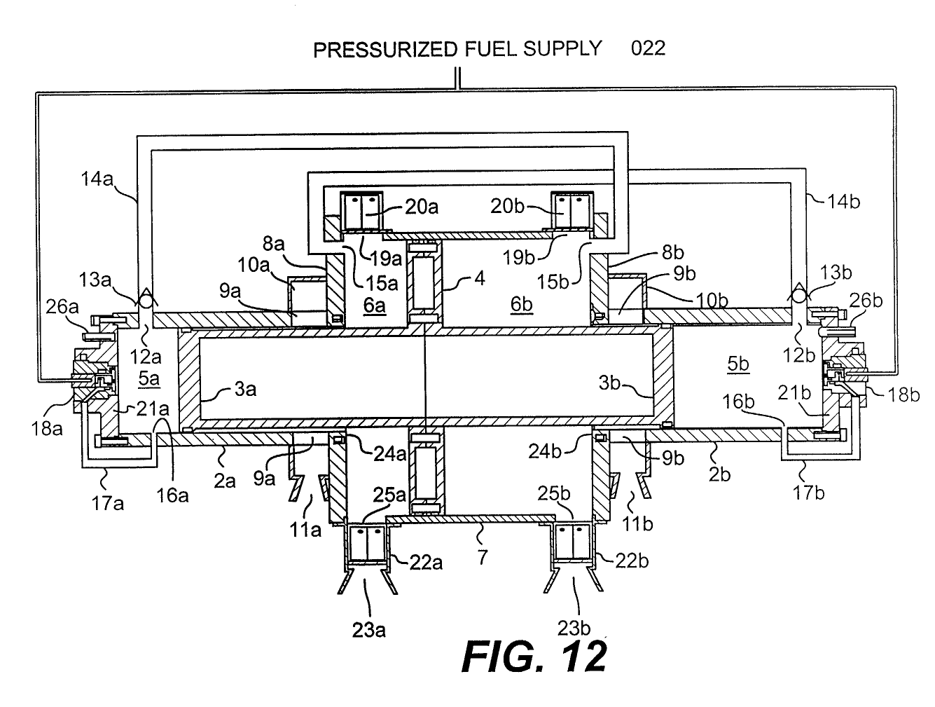

Referring to FIG. 12, the primary elements of a second embodiment of the invention which is essentially a free piston intermittent pulse rocket engine includes two combustion cylinders, 2a and 2b, coaxially located within, and separated by, a thrust chamber cylinder 7. The combustion pistons 3a, 3b and thrust piston 4 are connected and slidably inserted into cylinders 2a, 2b, and 7 respectively, forming combustion chambers 5a,5b and thrust chambers 6a,6b. Intake check valve assemblies 20a,20b provide a valved inlet for air into thrust chambers 6a,6b via thrust intake ports 19a,19b.

The opposing ends of combustion cylinders 2a,2b are closed by cylinder heads 21a,21b that contain fuel injectors 18a,18b, respectively. Fuel injectors 18a and 18b are fed by the pressurized fuel supply line 28. The opposing ends of thrust chambers 6a,6b are closed by thrust chamber flanges 8a,8b.

Injector control gas ports 16a,16b are provided in cylinders 2a,2b and are connected to injector gas control lines 17a,17b, respectively. The other ends of injector gas control lines 17a, 17b are, in turn, connected to fuel injectors 18a,18b. As further described below, injector control gas ports 16a,16b activate fuel Injectors 18a,18b as combustion pistons 3a,3b cross respective injector control gas port 16a,16b while moving on the compression stroke.

Exhaust ports 9a,9b formed in combustion chambers 2a,2b allow for expulsion and scavenging of burnt combustion gases via exhaust ducts 10a,10b and exhaust thruster nozzles 11a,11b. Scavenge purge lines 14a,14b allow high pressure air from thrust chambers 6b,6a to scavenge combustion chambers 5a,5b through scavenge ports 12a,12b and scavenge inlet ports 15a,15b, when pistons 3a,3b opens combustion chambers 5a,5b to exhaust. Scavenge port check valves 13a,13b prohibit counter-flow during the combustion, expansion and compression cycles of each combustion cylinder as further described below. Thrust chamber exhaust separators 24a,24b ensure separation of exhaust from combustion chambers 5a,5b to thrust chambers 6a,6b.

Main thruster check valves 22a, 22b interconnect main thruster nozzles 23a,23b with thruster ports 25a,25b and thrust chambers 6a,6b, respectively.

Pneumatic starter valves 26a, 26b allow compressed air from a compressed air source (not shown) to enter combustion chambers 5a,5b and permit engine starting.

### Operation of Second Embodiment Engine

Operation of the engine will be described here, while construction and operation of the preferred fuel injector 18 will be described in following paragraphs.

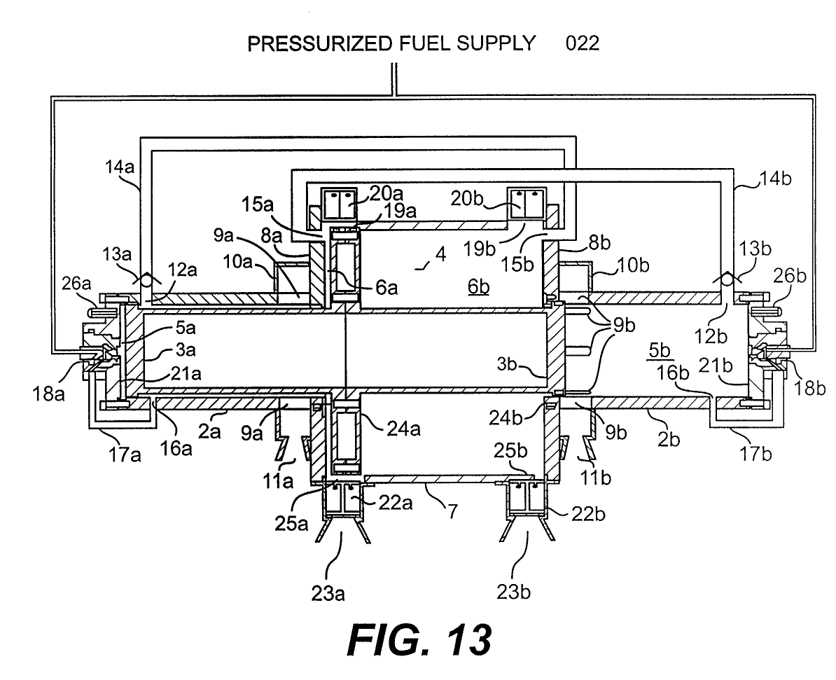

Assume that piston 3a is in its compression position to the left of cylinder 2a as shown in FIG. 13. When piston 3a is in its compression position, the volume of chamber 5a is at its minimum, and compression pressure therein is at a maximum. Fuel injection has been accomplished and combustion is underway. Piston 3b has opened chamber 5b to exhaust through ports 9b, exhaust duct 10b and exhaust nozzle 11b. Thrust chamber 6a has completed expulsion of its thrust gas and its pressure is approaching atmospheric. Thrust chamber 6b has completed its air intake stroke and is near atmospheric pressure. Injector gas control port 16a is at atmospheric pressure through exhaust port 9a. Check valve 13a is closed since thrust chamber 6b is at low intake pressure.

As the combined piston (3a-4-3b) begins moving to the right under the impetus of compression pressure and fuel combustion, the following actions occur:

Thrust chamber 6a begins intake of air through check valve 20a, while check valve 25a prevents entry of air through nozzle 23a.

Pressure builds up in thrust chamber 6b with the subsequent expulsion of air and generation of thrust through thruster port 25b, check valve 22b and nozzle 23b. Check valve 20b prevents loss of air through the inlet port 19b.

Piston 3b begins closure of cylinder 2b exhaust ports 9b.

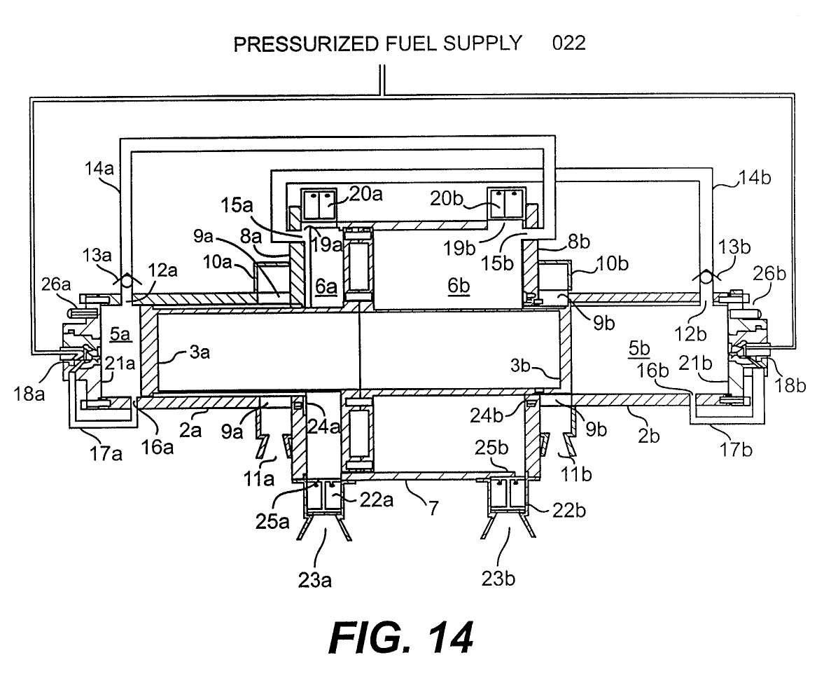

As shown in FIG. 14, when the combined piston (3a-4-3b) has moved right to the point where piston 3b has closed cylinder 2b exhaust ports 9b, the following actions have taken place or now occur:

Piston 3b begins compression of the combustion air in chamber 5b.

Piston 3a has uncovered scavenge port 12a, but check valve 13a prevents any flow.

Piston 3a has uncovered injector gas control port 16a and reset of the injector 18a for the next cycle has begun. This will be explained in a following paragraph describing injector operation.

Expansion of combustion gas in chamber 5a is increasing the velocity of piston 3a-4-3b to the right.

Under the impetus of piston 4, pressure is increasing in chamber 6b, with the resultant increase of mass flow and thrust out of nozzle 23b.

Chamber 6a is ingesting atmospheric air through valve 20a.

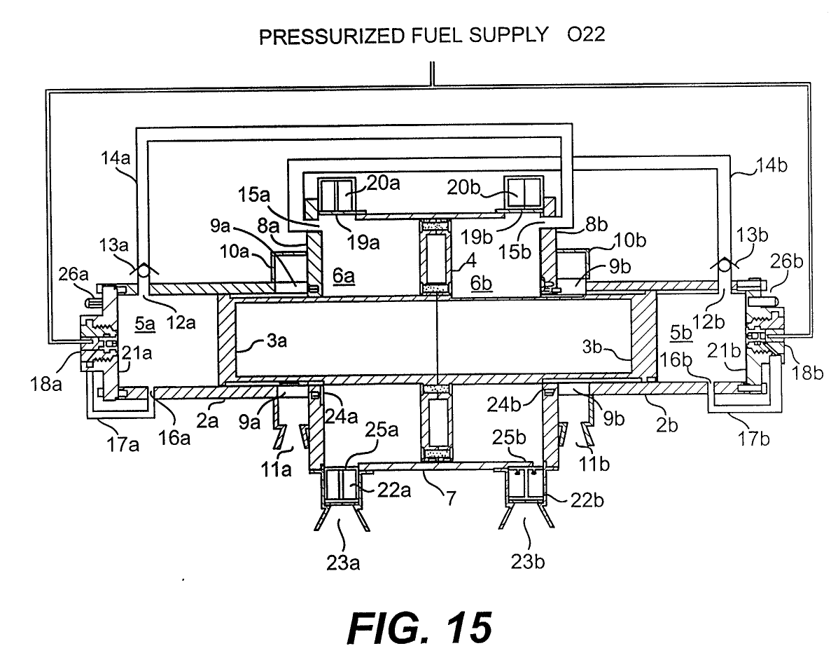

As shown in FIG. 15, when piston 3a is around mid point of its stroke in cylinder 2a, its maximum velocity is attained, and it begins to decelerate due to the pressure degradation in chamber 5a and the opposing forces generated by the increase in pressures in chambers 6b and 5b.

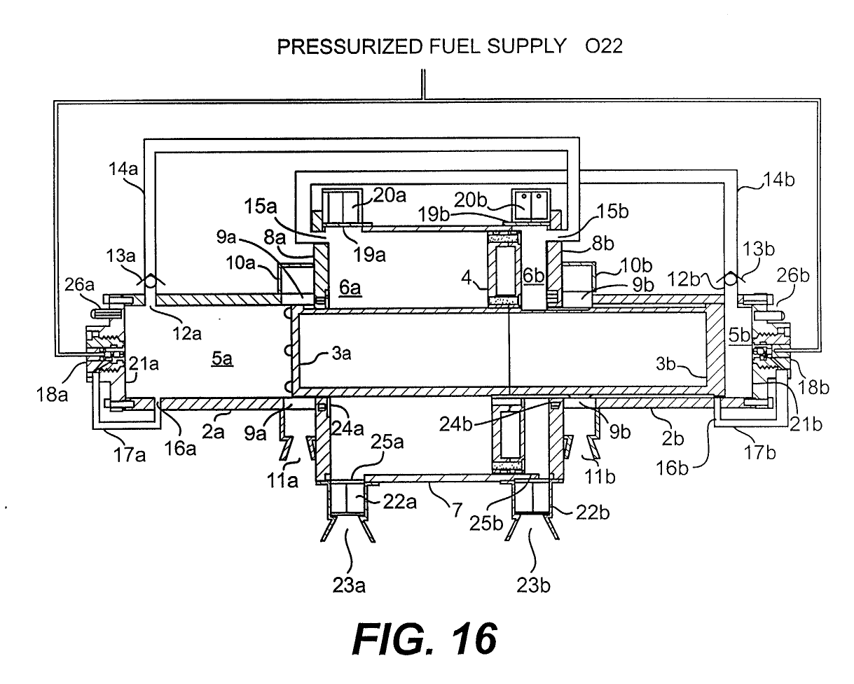

As shown in FIG. 16, when piston 3a crosses exhaust ports 9a, the following events have taken place or now occur:

Chamber 5a is vented to atmosphere through ports 9a and exhaust nozzle 11a, with some thrust generation.

The pressure in chamber 5a drops below the pressure in chamber 6b, thus allowing fresh air from chamber 6b to enter chamber 5a through port 15b, line 14a, check valve 13a, and port 12a. This air then scavenges chamber 5a through exhaust ports 9a and exhaust nozzle 11a. Note that the scavenged air is not wasted, but used to generate thrust through exhaust nozzle 11a.

Piston 3b is approaching the point of maximum compression in chamber 5b.

Piston 3b has crossed injector gas control port 17b and communicated it with exhaust ports 9b and nozzle 11b.

This begins activation of fuel injector 18b. This function will be explained in a paragraph. describing injector operation.

Chamber 6b is reaching maximum pressure, mass flow through check valve 25b and nozzle 23b, and is generating maximum engine thrust output.

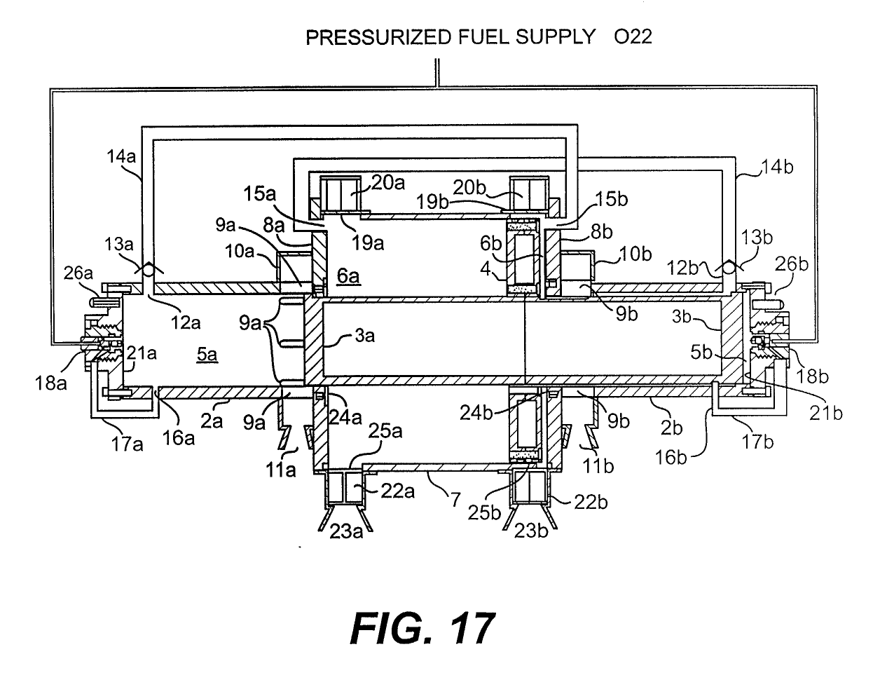

As shown in FIG. 17, the mass inertia of piston 3a-4-3b then carries it to the point of maximum compression pressure in chamber 5b, and its velocity reaches zero. At this time, the following conditions exist and the engine repeats the foregoing cycle in the opposite direction as follows:

Fuel injector 18b is injecting fuel into combustion chamber 5b and combustion has begun.

The pressure in thrust chamber 6b has decayed to atmospheric and scavenging of chamber 5a is complete, while chamber 5a remains open to exhaust and check valve 13a ceases interflow between 6b and 5a.

Thrust chamber 6a has ingested its maximum volume of air and is at near atmospheric pressure.

Starting of the engine may be accomplished via pneumatic starter valves 26a,26b. Specifically, a source of compressed air may be connected to at least one of the pneumatic starter valves 26a or 26b. For example, compressed air may be passed through pneumatic starter valve 26a and enter combustion chamber 5a thereby moving the piston (3a-4-3b) to the right until the operational state shown in FIG. 17 is achieved. At this point, the fuel injector 18b injects fuel into combustion chamber 5b, combustion begins, and the engine starts. Alternatively, a conventional igniter can be added to at least one of the cylinder heads 21a, 21b and utilized as a starting means with appropriate utilization of the pneumatic starter valves to inject compressed air to move the combined piston 3a-4-3b to a desired position, actuate a fuel injector 18 and thereby start the engine. Furthermore, pneumatic starter valves could also be added to the engine 1 of the first embodiment as an alternative method of starting that engine.

Furthermore, the system shown in FIG. 9 can be utilized with the engine of the second embodiment as indicated by the common usage of pressurized fuel line 022.

### Fuel Injector

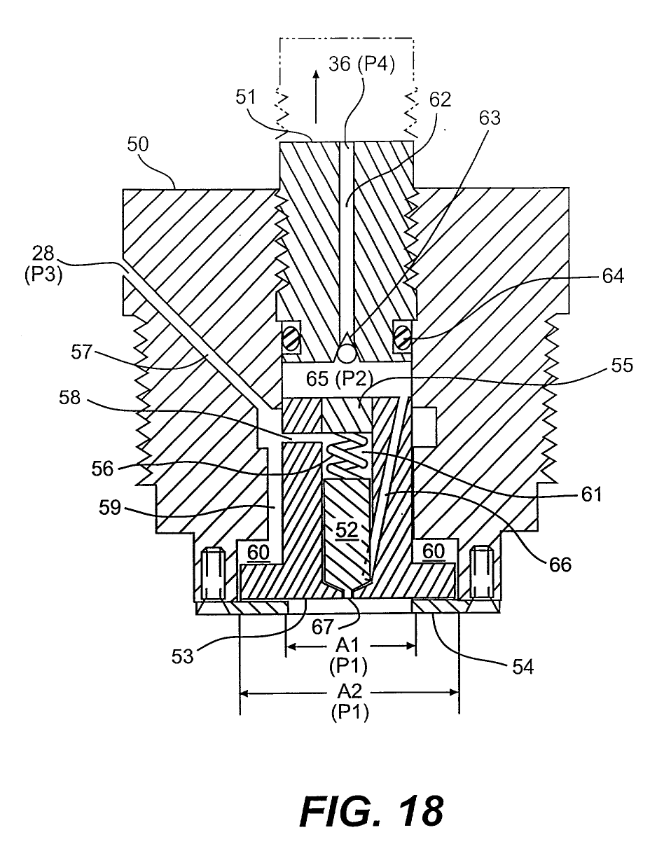

The engine of the second embodiment is preferably equipped with the fuel injector shown in FIG. 18. For ease of reference, fuel injectors 18a and 18b will be collectively referred to as fuel injector 18 it being understood that the same fuel injector 18 design is used for both 18a and 18b.

As shown in FIG. 18, the self-actuated, uniaxial fuel injector 18 consists of an injector body 50 into which is slidably mounted an intensifier piston 53 containing a slidably mounted fuel pintle 52, closure spring 56, and pintle stop 55. All of these elements are coaxially located. An annular intensifier piston cylinder stop 54 is attached on the combustion chamber side of the injector body 50 to constrain motion of the intensifier piston 53. On the opposite end, a fuel quantity plug and stop 51 with seal 64 is centrally located and threadably inserted into the injector body 50.

The fuel quantity plug and stop 51 contains the pressurized fuel inlet connection 36, fuel inlet passage 62, and check valve 63. The check valve 63 allows fuel to flow into the fuel cavity 65 when the cylinder pressure PI is less than the inlet fuel pressure P4, enabling the fuel cavity 65 to refill and reset the intensifier piston 53 when the combustion cylinder enters the exhaust phase. The threaded insertion of the fuel quantity and plug 51 into the injector body 50 allows for simple adjustment of the amount of fuel metered for each injection cycle.

When installing the fuel injector 18, the pressurized fuel inlet connection is connected to pressurized fuel line 022.

### Operation of Fuel Injector

The fuel injector 18 accomplishes the following functions: meter the amount of fuel required for a single combustion action; contain that fuel until injection is required; multiply the fuel injection pressure by the ratio of A1 to A2 above the cylinder compression pressure; inject the fuel into the combustion chamber when the engine piston crosses the gas control port; reset the pintle and intensifier piston, and refill the injector for the next cycle.

Refer to FIGS. 12 and 18 and assume that injector 18 is filled with fuel (fuel cavity 65 and passages 62 and 66) and ready to perform the injection function. As pressure (P1) rises in the cylinder chamber 5 during compression, the control gas inlet 28 (P3) and chambers 58, 60 and 61 track this pressure through gas control port 16 and injector gas control line 17 until piston 3 crosses gas control port 16. During this period, the annular volume and area 60 (P3) is at the same pressure as the compression chamber 5 (P1), thus, that portion of A2 is counterbalanced and the effective area under P1 is equal to A1. Since the top area of the slidable intensifier piston 53 in contact with the incompressible fuel in fuel cavity 65 is also equal to A1, the pressure in fuel cavity 65 (P2) is equal to P1. Also, since the gas control pressure P3 is communicated to control gas pintle cavity 61, the areas and pressures on top and bottom of the pintle 52 being equal, this allows the pintle closing spring 56 to maintain the pintle 52 in the closed position, thus preventing fuel flow into the cylinder chamber 5.

When the piston 3 has crossed gas control port 16, control gas inlet 28 (P3), passage 57 and chambers 58, 60, and 61 are vented to atmosphere through injector gas control line 17, gas control port 16, exhaust port 9, and exhaust nozzle 11. When this occurs, the effective area of the intensifier piston 53 exposed to the compression pressure P1 is now equal to A2, while the effective area on the opposite end in contact with the fuel in cavity 65 (P2) is still equal to A1. Thus, the fuel injection pressure P2 increases in the ratio of A2 to A1 (P1×A2=P2×A1) . This pressure increase is consistent with the operation of a conventional intensifier piston.

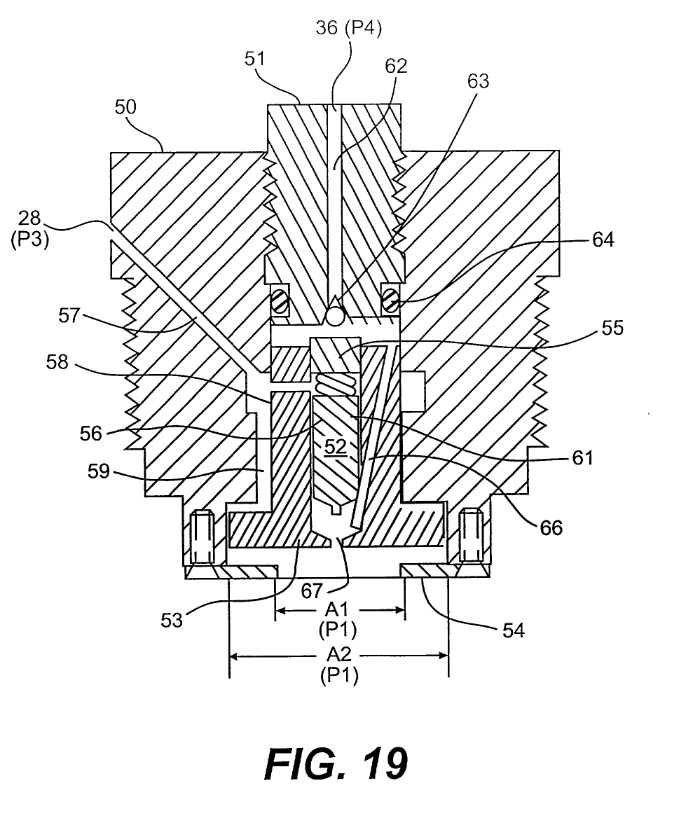

Typically, a cylinder compression pressure P1 of 1000 psi, might yield a fuel injection pressure P2 of 4000 psi, but this can be tailored for any specific design by appropriately adjusting, for example, A2 and A1. At the same time, the release of pressure in pintle cavity 61 allows compression pressure P1 and the increased fuel injection pressure P2 to act on the pintle 52 nose at injection nozzle 67, overcoming the force of the pintle closing spring 56 and causing the pintle to snap open. Fuel is now injected into combustion chamber 5 at pressure P2 until the fuel cavity 65 is depleted and the intensifier piston 53 contacts fuel quantity stop and plug 51 as shown in FIG. 19. Pressure P2 then drops to the more benign pressurized fuel inlet value P4, and any further fuel flow through the fuel delivery passage 66 is prevented by its inlet being in contact with the stop 51. This state and mechanical condition of fuel injector 18 remains constant until there is a change in the gas control pressure P3.

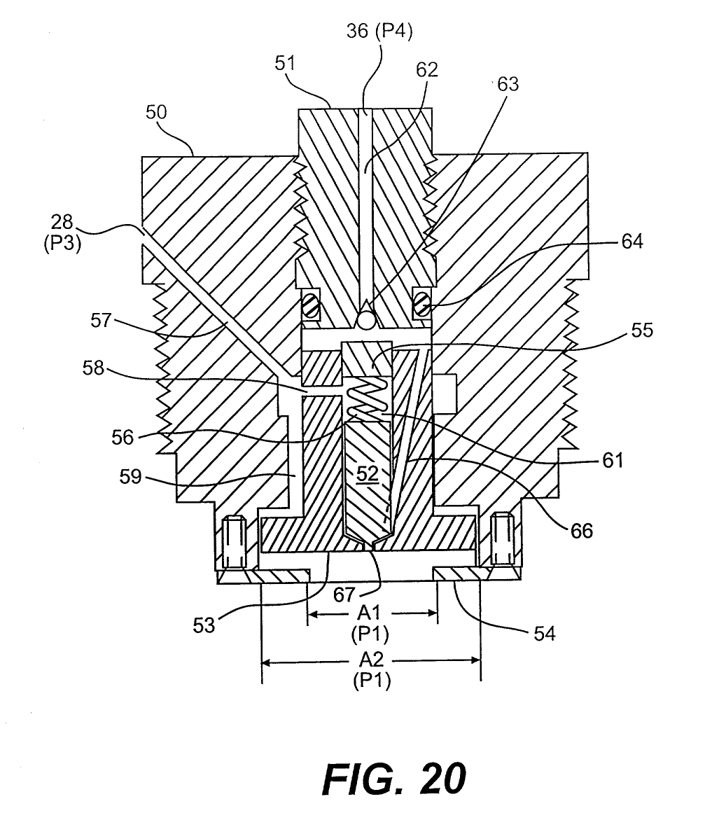

As piston 3 in cylinder 2 reverses direction for its power stroke under the impetus of compression pressure and combustion, piston 3 recrosses injector gas control port 16, again communicating control gas inlet 28 (P3) with combustion pressure P1 through injector gas control port 16 and gas control line 17. Gas control chambers 58, 60, and 61 then rise pressures equal to P1. Pintle 52 now has equal pressures on both ends, therefore, the pintle closing spring 56 causes the pintle 52 to return to its closed position as shown in FIG. 20, expelling any residual fuel in its cavity. Intensifier piston 53, however, has an effective area of A1 exposed to pressure P1, and since P1 is much higher than the fuel supply pressure P4, intensifier piston 53 will remain against stop 51 until piston 3 uncovers exhaust ports 9, and P1 in combustion chamber 5 decays to near atmospheric pressure. At this point, the fuel supply pressure P4 is greater than the chamber 5 pressure P1, fuel cavity 65 refills until intensifier piston 53 reaches piston cylinder stop 54. The fuel injector 18 is now reset, primed and ready for the next injection cycle.

The invention being thus described, it will be obvious that the same may be varied in many ways. Such variations are not to be regarded as departure from the spirit and scope of the invention, and all such modifications as would be obvious to one skilled in the art are intended to be included within the scope of the following claims.

1. A fuel injector comprising:
an injector body having a control gas passage, the control gas passage receiving a control gas pressure;
a fuel quantity plug/stop inserted into a first end of said injector body;
an intensifier piston having a fuel injector nozzle, said intensifier piston slidably disposed within said injector body between a first position in which a fuel cavity is formed between said intensifier piston and said fuel quantity plug/stop and a second position in which a volume of the fuel cavity is reduced;
said fuel quantity plug/stop including a fuel inlet passage in fluid communication with the fuel cavity;
said intensifier piston further including a control gas pintle cavity axially formed therein and a pintle cavity control gas passage in fluid communication with said control gas passage;
a intensifier piston stop provided at a second end of said injector body and preventing said intensifier piston from coming out of said injector body;
an intensifier piston control gas passage providing fluid communication between said control gas passage and said intensifier piston;
a pintle slidably disposed within said intensifier piston;
a pintle closing spring provided in said control gas pintle cavity and biasing said pintle against said fuel injector nozzle; and
a fuel delivery passage provided in said intensifier piston and interconnecting the fuel cavity and said pintle

2. The fuel injector according to claim 1,
wherein a fuel injection pressure P2 in said fuel cavity is increased by a ratio of A2/A1 and ejected at the increased pressure from said fuel injector nozzle, where A2=area of a first end of said intensifier piston and A1=area of a second end of said intensifier piston.

3. The fuel injector according to claim 1,
said intensifier piston further including a first end of a first diameter and first area A1 and a second end of a second diameter and a second area A2, the second diameter being larger than the first diameter and the second area A2 being larger than the first area A1;
wherein the different diameters of said intensifier piston are slidably disposed within corresponding bores in said injector body.

4. The engine according to claim 3,
wherein the control gas pressure is control gas pressure P3,
said intensifier piston stop being an annular member;
said control gas passage including an annular passage formed between said injector body and said intensifier piston at least when said intensifier piston is in the first position;
said first end of said intensifier piston being exposed to a fuel pressure P2 over area A1 from said fuel cavity;
wherein when the fuel injector is installed in an engine, said second end of said intensifier piston is exposed to a combustion chamber pressure P1 over area A2 from a combustion chamber;
said control gas passage receiving the control gas pressure P3 and communicating the control gas pressure P3 to said intensifier piston control gas passage, said pintle cavity control gas passage, and said control gas pintle cavity thereby applying the control gas pressure P3 to said intensifier piston and said pintle;
wherein said intensifier piston is in the first position when the control pressure P3 is substantially equal to pressure P1;
wherein said intensifier piston moves to the second position when the control pressure P3 drops to near atmospheric pressure thereby increasing an effective area of the second end of said intensifier piston to A2 and thereby increasing fuel pressure P2 by a ratio of A2/A1;
wherein when the drop in the control gas pressure P3 to near atmospheric pressure allows pressure P1 and increased pressure P2 to act on said pintle and overcome the bias applied by said pintle closing spring thereby causing said pintle to open and fuel to be ejected at pressure P2A2/A1 until said fuel cavity is depleted and said intensifier piston contacts said fuel quantity plug/stop.

5. The fuel injector according to claim 4,
said fuel inlet passage having a check valve therein;
said fuel inlet passage receiving fuel at a pressure of P4;
wherein after ejection of the fuel, pressure P2 drops to pressure P4 and further fuel flow through said fuel delivery passage is blocked by said check valve.

6. The fuel injector according to claim 5,
wherein restoration of the control gas pressure P3 to pressure P1 causes the fuel injector to reset.

7. The fuel injector according to claim 1, further comprising:
a seal located between said fuel quantity plug/stop and said injector body;
said fuel quantity plug/stop having a threaded connection with said injector body permitting said fuel quantity plug/stop to be rotated into or out of said injector body and thereby adjust a volume of said fuel cavity and a quantity of fuel to be injected.
